(19) United States
(12) Patent Application Publication
(10) Pub. No.: US 2007/0061879 A1
(43) Pub. Date: Mar. 15, 2007

(54) System and method for managing information handling system hard disk drive password protection

(76) Inventors: James E. Dailey, Round Rock, TX (US); Muhammed K. Jaber, Austin, TX (US)

Correspondence Address: HAMILTON & TERRILE, LLP, P.O. BOX 203518, AUSTIN, TX, 78720, US

(21) Appl. No.: 11/227,356

(22) Filed: Sep. 15, 2005

(51) Int. Cl. G06F 12/14

(52) U.S. Cl. 726/19

(57) ABSTRACT

Denial of service attacks on information handling system processing components having password protection, such as a hard disk drive, are prevented by automatically setting a password on the processing component during start-up of the information handling system if a password is not set. The automatically set password prevents a malicious program from illicitly setting a password on the processing component during operation of the information handling system. At power down, the automatically set password is removed to avoid interference with operation of the processing component during a subsequent start-up. In the event of an abnormal power down that fails to remove the automatically set password, the start-up process includes an attempt to unlock the processing component with the automatically set password.

### BACKGROUND OF THE INVENTION

1. Field of the Invention

The present invention relates in general to the field of information handling system hard disk drives, and more particularly to a system and method for managing information handling system hard disk drive password protection.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems are typically built from a number of discrete processing components, such as a central processing unit (CPU), RAM, a graphics controller, a chipset that supports a firmware BIOS, a network interface card (NIC), and a hard disk drive that provides permanent storage for information. In order to maintain security of information, an information handling system often uses password protection on a system level, generally managed by the BIOS and operating system, and also on individual components. The hard disk drive in particular typically includes password protection integrated in its firmware. Hard disk drive password protection adds an additional layer of security to stored information by locking out access to the stored information absent input of a password, even if a user has system level access.

One difficulty with the use of a hard disk drive password is that, if a user forgets or inadvertently changes the password, the system becomes unusable. If a hard disk drive has a password set, then the password typically cannot be modified by a user unless the user first knows and inputs the password. However, if no password is set on the hard disk drive, then it is normally possible to set any desired password on the drive. Thus, for instance, if a malicious program, such as a virus, illicitly sets a password on an unprotected drive, the drive becomes unusable on the next power up. To avoid such a “denial of service” attack on a hard disk drive, the ATA specification defines a “Password Freeze” command that causes a drive to ignore password commands until it is either power cycled or given a hardware RESET. Thus, to effectively attack a hard disk drive having a password freeze, the malicious program has to perform a RESET, which is generally controlled by the BIOS using one or more GPOs, typically a complex and system-specific process.

Recently, the Serial ATA (SATA) standard was introduced to provide improved performance for storing information compared with the ATA standard. Like ATA compliant drives, in order to prevent “denial of service” attacks SATA drives freeze the password until the drive is power cycled or reset. However, unlike ATA drives, a reset is accomplished relatively easily with a simple PCI configuration write to disable and then re-enable the SATA port controlling the drive. The PCI writes cause a COMRESET sequence, which “unfreezes” the SATA drive to become vulnerable to the setting of a password unless the user has already set a password. Although a SATA feature, known as Software Settings Preservation, has a default condition that prevents a SATA drive from becoming “unfrozen” as described above, a standard command sequence is available to disable this feature.

### SUMMARY OF THE INVENTION

Therefore a need has arisen for a system and method which prevents malicious programs from illicitly setting a password on an information handling system processing component.

In accordance with the present invention, a system and method are provided which substantially reduce the disadvantages and problems associated with previous methods and systems for protecting processing components from malicious program denial of service attacks. During operation of the information handling system, an automatically determined password is set on processing components that do not have user determined password. The presence of the automatically determined password on the processing component prevents a malicious program from illicitly setting a password to deny service of the processing component unless the malicious program can first determine and input the automatically determined password.

More specifically, an information handling system hard disk drive having password protection interfaces with a password set engine during start-up of the information handling system, such as through BIOS POST instructions. The password set engine determines if a user determined password is set on the hard disk drive and, if not, automatically sets a password created by a password generator, such as by algorithmically deriving the password from the serial number of the hard disk drive. The automatically set password prevents a malicious program from illicitly setting a password in an attempt to deny service of the hard disk drive unless the malicious program can first input the automatically set password within a limited number of attempts. The automatically set password is removed during power down of the information handling system by a password remove engine to reduce the risk of difficulty in subsequent use of the hard disk drive. In the event that the automatically set password is not removed, such as during an abnormal power down, the password set engine detects the use of a password on the next start-up and applies the automatically determined password to attempt to unlock the hard disk drive before requesting the input of a password by the user.

The present invention provides a number of important technical advantages. One example of an important technical advantage is that a malicious program cannot illicitly set a hard disk drive password because the automatically generated password is required in order for the malicious program to set a denial of service password. The use of the automatically generated password in the hard disk drive is hidden from the user and has no impact on system performance. The cost of protecting the hard disk drive with an automatically generated password is minimal, typically using a slight firmware modification integrated during manufacture of the drive or applied during manufacture of the information handling system, such as BIOS instructions.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of an information handling system having password protection managed to prevent denial of service attacks against a hard disk drive; and

FIG. 2 depicts a flow diagram of a process for automatically setting a password at an information handling system processing component to prevent a denial of service attack against the component.

### DETAILED DESCRIPTION

Automatically setting a hard disk drive password prevents a malicious program from illicitly setting a password to deny service of the hard disk drive. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

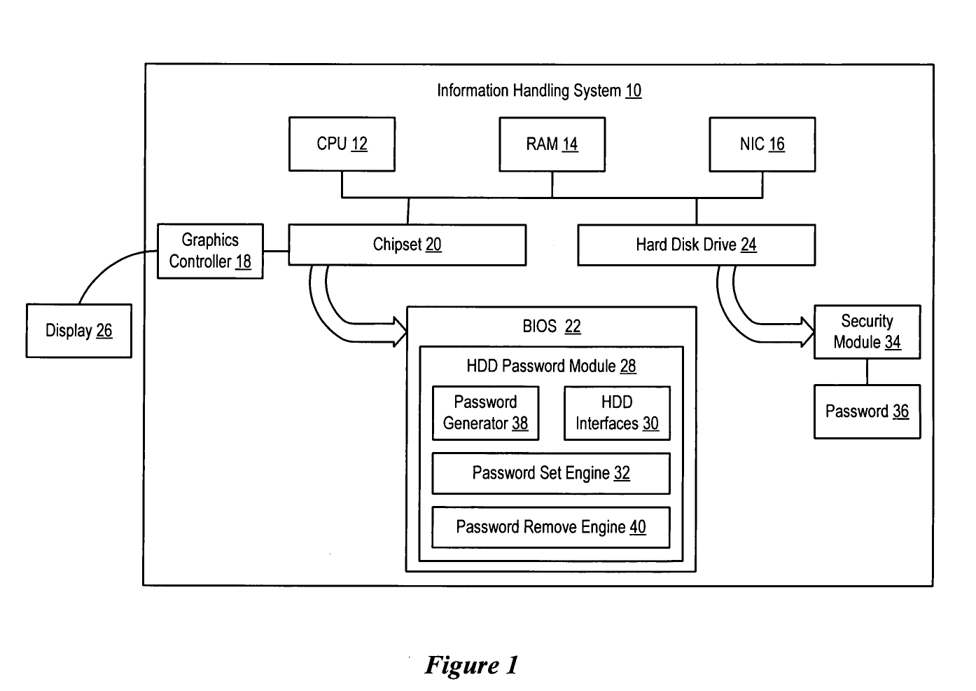

Referring now to FIG. 1, a block diagram depicts an information handling system 10 having password protection managed to prevent denial of service attacks against a hard disk drive. Information handling system 10 is built with plural processing components that coordinate to process information, such as a CPU 12, RAM 14, NIC 16, a graphics controller 18, a chipset 20 supporting a BIOS 22 and a hard disk drive 24. For instance, applications run on CPU 12 interface with networks through NIC 16 to present information at a display 26. Communication with external networks presents a security risk, such as the downloading of malicious programs like viruses. One danger presented by malicious programs is a “denial of service” attack that makes processing components unusable by setting a password to restrict access to the processing components. Hard disk drive 24 is relatively safe from a denial of service attack if a password is already set since the malicious program must correctly input the existing password within five attempts in order to change to an illicit password. However, if no password is set on hard disk drive 24, then the malicious program generally needs only to cause a reset and input the illicit password.

To prevent malicious program denial of service attacks on hard disk drive 24, a hard disk drive password module 28 resides in BIOS 22 and ensures that either a user determined password or an automatically set password is set on hard disk drive 24 when information handling system 10 is operational. During start-up of information handling system 10, such as during POST, hard disk drive password module 28 is called. A hard disk drive interface 30 communicates a query from a password set engine 32 to a security module 34 of hard disk drive 24 to see if a password 36 is set. If the query shows that a password is already set on hard disk drive 24, then password set engine 32 allows the system boot to continue since the presence of password 36 on hard disk drive 24 will prevent a denial of service attack. If the query shows that no password is set on hard disk drive 24, then password set engine 32 gets a predetermined password from a password generator 38 and sets the predetermined password in hard disk drive 24. For instance, password generator 38 applies the serial number of hard disk drive to an algorithm that creates a password that is repeatable by application of the algorithm but difficult to reproduce without the algorithm. In one embodiment, the predetermined password is algorithmically derived to include at least one character that user cannot enter in the normal course of setting a hard disk drive password to ensure that the user does not adopt the predetermined password as his own. The predetermined password remains on hard disk drive 24 while information handling system 10 is operational, thus precluding a malicious program from illicitly setting a password on hard disk drive 24.

Setting the password provided by password generator 38 protects against malicious program denial of service attacks, however, the presence of a password can inhibit normal user operations. In order to reduce the risk of interference with normal operations by the predetermined password, a password remove engine 40 is called during normal power down of information handling system 10, such as a complete power down to an off state or a power down to a reduced power state like S3. Password remove engine 40 checks to see if the predetermined password is set on hard disk drive 24 and, if so, removes the predetermined password before power down so that the password will not interfere with a subsequent restart of information handling system 10. In the event that a shutdown of information handling system 10 is not normal so that the predetermined password remains on hard disk drive 24 at the next start-up, password set engine 32 applies the predetermined password to unlock hard disk drive 24 for normal start-up and use. Similarly, if a legitimate request for the predetermined password is made, such as a user request to create a password, then the predetermined password is provided by password generator 38. Although hard disk drive module 28 described above manages the application of a predetermined password to prevent a denial of service attack on a hard disk drive, in alternative embodiments other types of processing components that have password protection may be managed in a similar manner. Further, although hard disk drive password module 28 operates from firmware within BIOS 22, in alternative embodiments module 28 may run from alternative locations, such as firmware within hard disk drive 24.

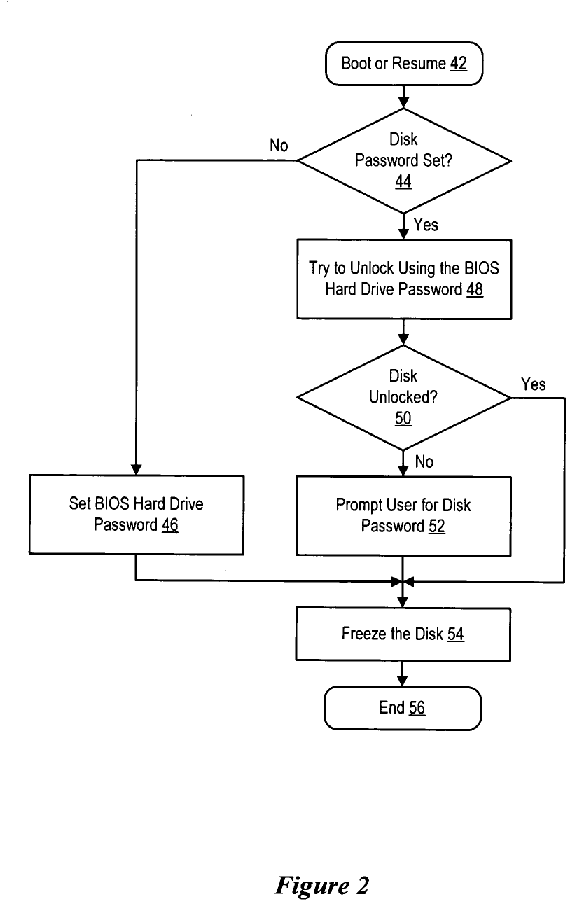

Referring now to FIG. 2, a flow diagram depicts a process for automatically setting a password at an information handling system processing component to prevent a denial of service attack against the component. The process begins at step 42 with a start-up of the information handling system, such as a boot or a resume. At step 44 a determination is made of whether a hard disk drive password is set. If not, the process continues to step 46 to set a BIOS hard disk drive password, such as a password algorithmically derived from the hard disk drive serial number, and the process continues to step 54 to freeze the hard disk drive from password changes. If a password is set at step 44, the process continues to step 48 to attempt unlock the hard disk drive using the BIOS hard drive password. If, at step 50, the hard disk drive unlocks in response to the BIOS hard disk drive password, then the password was not removed at the previous shutdown and the process continues to step 54 to freeze the hard disk drive. In the event that the BIOS hard drive password is already set, it does not have to be reset before freezing the hard disk drive. If, at step 50, the hard disk drive does not unlock in response to the BIOS hard drive password, the process continues to step 52 to prompt the user to input a user determined password. Once the user inputs that password, the process continues to step 54 to freeze the hard disk drive since the presence of a user determined password makes the setting of a BIOS hard drive password unnecessary. The process ends at step 56 with the hard disk drive frozen and a password set so that a malicious program cannot set an illicit password.

Although the present invention has been described in detail, it should be understood that various changes, substitutions and alterations can be made hereto without departing from the spirit and scope of the invention as defined by the appended claims.

What is claimed is:

1. A method for managing password protection of an information handling system hard disk drive, the method comprising:
determining during start-up of the information handling system whether a password is set on the hard disk drive;
if a password is not set on the hard disk drive, then automatically setting a predetermined password on the hard disk drive; and
automatically removing the predetermined password during power down of the information handling system.

2. The method of claim 1 further comprising:
if a password is set on the hard disk drive, then attempting to unlock the hard disk drive with the predetermined password; and
continuing the start-up if the hard disk drive unlocks with the predetermined password.

3. The method of claim 2 further comprising:
prompting a user of the information handling system to input a hard disk drive password if the predetermined password fails to unlock the hard disk drive.

4. The method of claim 1 wherein the power down of the information handling system comprises shutdown to an off state.

5. The method of claim 1 wherein power down of the information handling system comprises powering down to a reduced power consumption state.

6. The method of claim 1 further comprising:
automatically generating the predetermined password from a serial number of the hard disk drive.

7. The method of claim 6 further comprising:
ensuring that the predetermined password comprises at least one character that is not reproducible by a user interface of the information handling system.

8. The method of claim 1 wherein the automatically setting a predetermined password further comprises setting the predetermined password with BIOS POST instructions.

9. A system for managing password protection of an information handling system hard disk drive, the system comprising:
a password set engine operable on start-up of the information handling system to determine whether a password is set on the hard disk drive and, if a password is not set on the hard disk drive, to set a predetermined password on the hard disk drive; and
a password remove engine operable on power down of the information handling system to remove the predetermined password from the hard disk drive.

10. The system of claim 9 further comprising a password generator operable to algorithmically generate the predetermined password.

11. The system of claim 10 wherein the predetermined password is algorithmically generated from a serial number of the hard disk drive.

12. The system of claim 9 wherein the password set engine is further operable to attempt to unlock the hard disk drive with the predetermined password if a password is set on the hard disk drive.

13. The system of claim 12 wherein the password set engine is further operable to prompt a user to input a hard disk drive password if the predetermined password fails to unlock the hard disk drive.

14. The system of claim 9 wherein the password set engine and password remove engine comprise instructions residing in a BIOS of an information handling system.

15. The system of claim 9 wherein the password set engine and password remove engine comprise instructions residing in firmware of the hard disk drive.

16. An information handling system comprising:
plural processing components interfaced to process information, at least one of the processing components having password protection available with a user-determined password;
a password set engine interfaced with the processing component having the password protection, the password set engine operable to set a predetermined password in the processing component on start-up of the information handling system if the processing component lacks a user-determined password; and
a password remove engine interfaced with the processing component having the password protection, the password remove engine operable to remove the predetermined password from the processing component on power down of the information handling system.

17. The information handling system of claim 16 wherein the processing component having password protection comprises a hard disk drive.

18. The information handling system of claim 16 wherein the processing component having password protection further has a serial number, the predetermined password comprising characters algorithmically derived from the serial number.

19. The information handling system of claim 18 wherein at least one of the predetermined password characters comprises a character not reproducible from an input device of the information handling system.

20. The information handling system of claim 16 wherein the password set engine is further operable to attempt to unlock the processing component having password protection with the predetermined password if a password is set on the processing component.
